(19) United States
(12) Patent Application Publication
(10) Pub. No.: US 2016/0304018 A1
(43) Pub. Date: Oct. 20, 2016

(54) VEHICLE MAT

(71) Applicant: Nayemul Chowdhury, Ozone Park, NY (US)

(72) Inventor: Nayemul Chowdhury, Ozone Park, NY (US)

(21) Appl. No.: 14/688,178

(22) Filed: Apr. 16, 2015

(51) Int. Cl. B60N 3/04

(52) U.S. Cl. CPC B60N 3/048; B60N 3/044; B60N 3/046

(57) ABSTRACT

An improved vehicle mat for use in a vehicle having at least one removable carpet vehicle mat, comprising; a thin pad having a front side and a rear side, the front side having a plurality of the ribs thereon to increase traction and to collect fluid or debris; a removable or fixed gripping portion or clamp having a curved segment and a gripping segment; the curved segment for holding the mat with respect to the removable carpet vehicle mat; and the gripping segment for clasp attaching the clasp on the pad.

### FIELD OF THE INVENTION

This invention relates to protective mats for automobiles and other vehicles, such as SUV's, pickup trucks, trucks, wagons, and vans. More particularly, this invention relates to improved devices and methods for preventing slippage of mats inside vehicles.

### BACKGROUND OF THE INVENTION

Vehicles, such as automobiles and various types of trucks often have carpet on the floor of the passenger compartments, in both the front and back seats, where present. These carpets are generally affixed to the floor panels of the vehicle, and cannot easily be lifted or removed for cleaning. As a result, the vehicles are often equipped with additional carpet mats that protect the underlying carpet flooring in the passenger or driver's area of the vehicle. Often, each carpet mat is rectangular and may or may not be attached to the base carpet or flooring through fasteners such as snaps or similar fasteners. These mats, which are also often made of carpet, have a rather stiff backing, and may not offer the type of protection that a particular climate or vehicle use requires. They may also absorb large amounts of dirt, water, and other debris, which can damage the carpet mats and allow the dirt to build up on both the mat and the carpeting underneath the mat in the vehicle.

Thus, for some vehicle uses, an additional mat may be desired to protect the mat and the carpet from wear and tear or objects that may tend to harm either the mat or the carpet. Such mats often do not have any means to hold them in place and can shift around, allowing mud or other debris from the driver's or passengers' shoes or boots to land on the mat or the carpet beneath the mat.

It would be desirable, therefore, to have a supplemental mat that includes a fastening means to prevent slippage of the mat when in use. Such fastening means for the supplemental mat would advantageously be removable, to allow it to lie flat when used in some specific applications where the attachment or fastening means is unnecessary.

### SUMMARY OF THE INVENTION

The disadvantages of prior devices are overcome and the objects of the invention are achieved by providing an improved mat for a vehicle comprising an elongated vinyl or plastic rectangular pad including at least one longitudinal edge, the pad having a plurality of ribs or other raised protrusions to collect debris and liquid in recesses included between such ribs or other indentations, to allow collection or pooling of fluid, while providing traction when contacted with the shoe or boot of the vehicle occupant. The invention includes a removable or fixed clamping mechanism to hold the mat in place on the carpet mat that it covers. The gripping and clamping mechanism preferably is a generally L-shaped segment that extends longitudinally along the longer side of the mat, and is fastened to the mat using a frictional or slidable grip or is embedded permanently within the mat.

### BRIEF DESCRIPTION OF THE DRAWINGS

Further features and advantages of the invention may be understood from a review of the following detailed description of the preferred embodiments taken in connection with the attached drawings, in which:

FIG. 1 is a perspective view of the improved vehicle mat of the present invention overlying a carpet mat removably fastened to a vehicle floor (not shown);

FIG. 2 is a rear view of the improved vehicle mat of FIG. 1;

FIG. 3 is a bottom perspective view of the vehicle mat shown in FIG. 1, partially broken away;

FIG. 4 is a perspective view of the gripping portion of the improved vehicle mat of FIG. 1;

FIG. 5 is end view of another embodiment of the gripping portion of the improved vehicle accessory mat of FIG. 1;

FIG. 6 is an end view of the gripping portion shown in FIG. 4; and

FIG. 7 is an end view of embodiment of the improved vehicle at shown in FIG. 3.

### DETAILED DESCRIPTION OF THE PREFERRED EMBODIMENTS

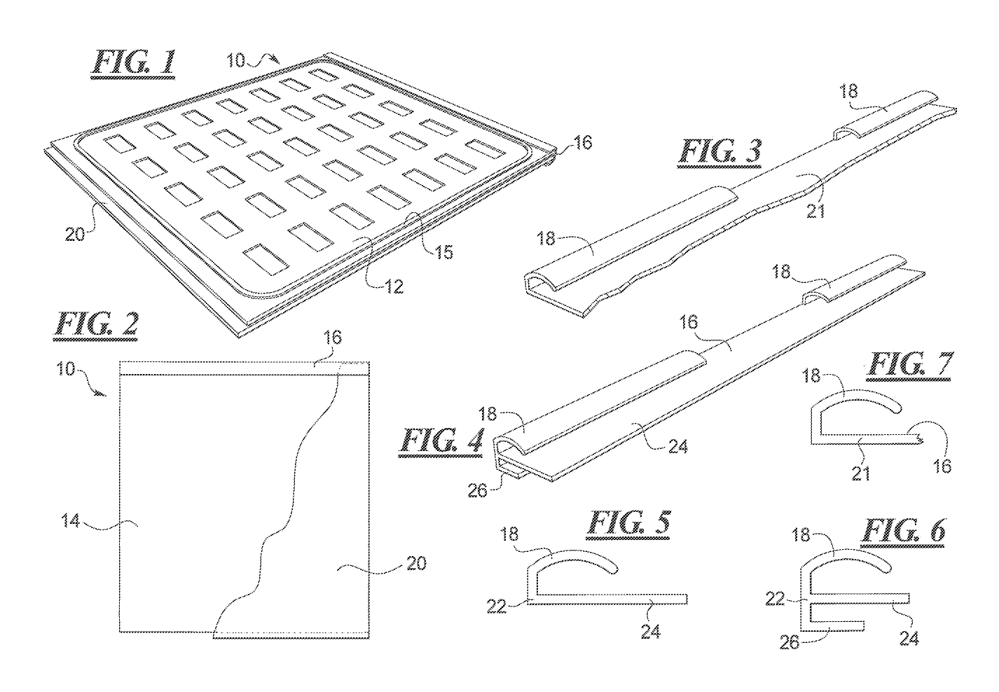

Referring to the drawings, FIG. 1 illustrates the improved vehicle accessory mat of the present invention, generally designated by the reference numeral 10. The vehicle accessory mat 10 includes a front side 12, a rear side 14 (see FIG. 2), and a removable or fixed gripping portion or clamp 16 to hold the car mat 14 in place on a conventional carpet mat 18 which is fastened to underlying carpet or flooring in a vehicle (not shown).

The vehicle accessory mat 10 may have one of several different shapes and sizes, depending on how it will be used. For example, the vehicle accessory mat 10 can fit in the foot well of a passenger car, between the car door and the raised tunnel for the transmission, drive train, or gear shift (not shown), or it may be an elongated vehicle accessory mat 10 that extends substantially from adjacent one car door to the other, including two wells and the raised tunnel (not shown). For use in the driver's compartment, the improved vehicle mat 10 can extend part way up the partition or wall between the passenger compartment and the engine. In such case, the vehicle mat 10 may include cut outs for the foot pedals (not shown) or it may just cover the floor portion of the well.

Similarly, on the front passenger side, the vehicle mat 10 may extend part way up the wall between the passenger and engine compartments, as desired to cover the carpet mat affixed to this car's floor. The improved vehicle mat 10 should be made of rubber, synthetic rubber, or a flexible plastic material such as polyvinylchloride or other suitable polymer or plastic material that can be molded into the desired size, shape, and thickness. The mat can be approximately ⅛ to ¼ inches in thickness, depending upon material of construction and intended use, and may have a rim 15 (see FIG. 1) to contain liquid and dirt.

In either case, the improved vehicle mat 10 has a gripping portion 16, as shown in FIGS. 1 and 2. The gripping portion 16 can be attached to the ear mat 10 so that it can be removed as shown in FIGS. 4 and 6, or it can be permanently affixed or integrated into the mat 10 structure, by sandwiching or embedding the gripping portion into the mat during manufacture. FIG. 3 shows a gripping portion 18 integrated with the mat 21, which extends therefrom. The gripping portion includes a curved section 18 to grasp and hold a conventional, removable, carpet car mat 20, as shown in FIG. 4. The gripping potion 18 may extend the length of the vehicle mat 10, as shown in FIG. 1, or it may have one or more segments 18 shorter in length than the dimension of the vehicle mat 10, as shown in FIG. 4. Alternatively, the damp 18 may also overlie the mat itself, as shown in FIGS. 3 and 7.

The construction, attachment and removal, of the gripping portion or mechanism 16 may be understood with reference to FIGS. 3 through 7. In another embodiment, the gripping portion may be removable, as shown in FIGS. 4 and 6. The gripping portion 18 fits tightly on the conventional carpet vehicle mat 20, between legs 24 and 26, and retains the vehicle mat 10 in place. This in turn prevents slippage, which can cause dirt, mud, and other debris to land on the carpet mat or the carpet lining the vehicle floor. Additionally, affixing the improved vehicle mat 10 to the underlying conventional carpet mat 20 avoids having the mat 10 interfere with operation of the accelerator or brake pedals, and helps to maintain a neat appearance in the vehicle. The gripping portion 18 should preferably be made from nylon or a plastic having spring-like resilient properties. Alternatively, the gripping portion 22 can be spring steel painted to avoid corrosion or rust. In one embodiment, the gripping portion can be permanently affixed to the carpet mat 10, by sandwiching the base 24 between layers of the mat 10, embedding the base 24 within the mat when molding the mat, or by affixing the base 24 rigidly to the rear side 20 of the mat 10, using the gripping mechanism shown in FIG. 5. In such case, the gripping portion 18 would not have a bottom edge or leg 26, as it would not be needed (see FIG. 5). in other embodiments, as mentioned above, the vehicle mat 10 can have a removable gripping portion 16, as shown in FIGS. 4 through 6.

It should be apparent to those of ordinary skill in the art that various modifications can be made to the improved vehicle mat of the present invention without departing from the spirit or scope thereof. It is therefore intended that all such modifications be included in the scope of the invention as defined by the following claims.

1. An improved vehicle mat for use in a vehicle having at least one removable carpet vehicle mat, comprising:
a thin pad having a front side and a rear side, the front side having a plurality of channels or depressions, thereon to increase traction and to collect fluid or debris;
a removable gripping member having a curved segment and a gripping portion and extending from the rear side of the vehicle mat;
the removable gripping member for holding the mat with respect to the removable carpet vehicle mat; and the gripping portion for retaining the pad with the carpet mat by attaching a clasp on the pad.

2. An improved vehicle mat according to claim 1, wherein the gripping member frictionally engages the pod to adhere the clasp to the pad.

3. An improved vehicle mat for use in a vehicle having at least one removable carpet vehicle mat, comprising:
a thin pad having a front side and a rear side, the front side having a plurality of ribs thereon to increase traction and collect fluid or debris;
a gripping member extending from the rear side of the vehicle mat and having a base integrated within in the pad and a clamp portion for capturing and retaining the carpet vehicle mat.

4. The vehicle mat of claim 3 wherein the base of the gripping member is embedded in the rear side of the pad when molding the pad.

5. The vehicle mat of claim 3 wherein the gripping member is sandwiched between pad layers and extends to the rear side of the mat.
